(19) United States
(12) Patent Application Publication
(10) Pub. No.: US 2024/0365769 A1
(43) Pub. Date: Nov. 7, 2024

(54) Controlling Spray Heads

(71) Applicant: AGTECNIC PTY LTD, Brisbane (AU)

(72) Inventors: Peter James Roberts, Brisbane (AU); Robert James Johnson, Brisbane (AU); Matthew James Fraser, Brisbane (AU)

(21) Appl. No.: 18/561,116

(22) PCT Filed: Apr. 26, 2022
(86) PCT No.: PCT/AU2022/050381

§ 371 Date: Nov. 15, 2023

(30) Foreign Application Priority Data
May 17, 2021 (AU) 2021901471

(51) Int. Cl. A01M 7/00; G01J 3/46; G06T 7/90

(52) U.S. Cl. CPC A01M 7/0089; G01J 3/463; G06T 7/90; G06T 2207/30188

(57) ABSTRACT

A method of controlling at least one spray head of a crop sprayer includes capturing, as the crop sprayer traverses a field, a color image of an area of the field to be potentially sprayed by a first spray head, dividing at least part of the captured image into a first set of sub-areas, determining whether at least a defined number of the sub-areas corresponding to the first spray head include at least a defined number of pixels having defined color values corresponding to foliage to be sprayed, and activating the first spray head upon at least the defined number of the sub-areas areas corresponding to the first spray head having more than the defined threshold of pixels within the defined color values.

### FIELD OF INVENTION

The invention relates to a method and apparatus for controlling at least one spray head of a crop sprayer.

### BACKGROUND

Crop spraying techniques are known where sensors are used to gather data about a field to be sprayed, the data is processed in order to identify foliage that is to be sprayed, and the spray heads of a crop sprayer are controlled in order to selectively spray the identified foliage. A typical application is the more targeted use of chemicals on weeds. This can result in a reduction of the amount of chemicals used on the field.

There is a need for alternative techniques for identifying foliage. Such alternatives may enable foliage to be identified with greater certainty or at lower cost.

### SUMMARY OF THE INVENTION

According to a first aspect of the invention, there is provided a method of controlling at least one spray head of a crop sprayer, the method comprising the steps of:
(a) capturing, as the crop sprayer traverses a field, a color image of an area of the field to be potentially sprayed by a first spray head;
(b) dividing at least part of the captured image into a first set of sub-areas;
(c) determining whether at least a defined number of the sub-areas corresponding to the first spray head include at least a defined number of pixels having defined color values corresponding to foliage to be sprayed; and
(d) activating the first spray head upon at least the defined number of the sub-areas areas corresponding to the first spray head having more than the defined threshold of pixels within the defined color values.

In an embodiment, the method comprises determining whether to activate the first spray head in step (d) after determining in step (c) whether each of the sub-areas includes more than a defined threshold of pixels having defined color values corresponding to foliage to be sprayed.

In an embodiment, the method comprises determining whether to activate the spray head in step (d) after each determination in step (c) that an individual one of the first set of sub-areas includes more than a defined threshold of pixels having defined color values corresponding to foliage to be sprayed.

In an embodiment, the method further comprises:
determining whether to activate the first spray head in step (d) after:
dividing at least part of the captured image into a second set of sub-areas arranged in offset, overlapping relationship with at least a portion of the first set of sub-areas; and
determining whether at least a defined number of the first and second sets of sub-areas include at least a defined number of pixels having defined color values corresponding to foliage to be sprayed.

In an embodiment, the method comprises, upon the spray head not having been activated:
dividing at least part of the captured image into a second set of sub-areas arranged in offset, overlapping relationship with at least a portion of the first set of sub-areas; and
determining whether to activate the first spray head in step (d) after each determination that an individual one of the second set of sub-areas includes more than a defined threshold of pixels having defined color values corresponding to foliage to be sprayed.

In an embodiment the captured color image also corresponds to an area of the field to be potentially sprayed by a second spray head, and the method comprises:
determining whether at least a defined number of sub-areas corresponding to the second spray head include at least a defined number of pixels having defined color values corresponding to foliage to be sprayed; and
activating the second spray upon at least the defined number of the sub-areas corresponding to the second spray head having more than the defined threshold of pixels within the defined color values.

In an embodiment, at least a portion of the second set of sub-areas correspond to both the first and second spray heads.

In an embodiment, the color values are in the CIELAB color space.

In an embodiment, the defined color values correspond to a volume within the CIELAB color space.

In an embodiment, the defined number of sub-areas is one sub-area.

In a second aspect, the invention provides apparatus for controlling at least one spray head of a crop sprayer:
a camera for capturing, as the crop sprayer traverses a field, a color image of an area of the field to be potentially sprayed by a first spray head; and
a controller coupled to the camera and the spray head, the controller configured to:
(a) divide at least part of the captured image into a first set of sub-areas;
(b) determine whether at least a defined number of the sub-areas corresponding to the first spray head include at least a defined number of pixels having defined color values corresponding to foliage to be sprayed; and
(d) activate the first spray head upon at least the defined number of the sub-areas areas corresponding to the first spray head having more than the defined threshold of pixels within the defined color values.

In an embodiment, the controller is further configured to determine whether to activate the first spray head in step after determining whether each of the sub-areas includes more than a defined threshold of pixels having defined color values corresponding to foliage to be sprayed.

In an embodiment, the controller is further configured to determine whether to activate the spray head in after each determination that an individual one of the first set of sub-areas includes more than a defined threshold of pixels having defined color values corresponding to foliage to be sprayed.

In an embodiment, the controller is further configured to determine whether to activate the first spray head after:
dividing at least part of the captured image into a second set of sub-areas arranged in offset, overlapping relationship with at least a portion of the first set of sub-areas; and
determining whether at least a defined number of the first and second sets of sub-areas include at least a defined number of pixels having defined color values corresponding to foliage to be sprayed.

In an embodiment, the controller is further configured to, upon the spray head not having been activated:
divide at least part of the captured image into a second set of sub-areas arranged in offset, overlapping relationship with at least a portion of the first set of sub-areas; and
determine whether to activate the first spray head in step (d) after each determination that an individual one of the second set of sub-areas includes more than a defined threshold of pixels having defined color values corresponding to foliage to be sprayed.

In an embodiment, the captured color image also corresponds to an area of the field to be potentially sprayed by a second spray head, and the controller is configured to:
determine whether at least a defined number of sub-areas corresponding to the second spray head include at least a defined number of pixels having defined color values corresponding to foliage to be sprayed; and
activate the second spray upon at least the defined number of the sub-areas corresponding to the second spray head having more than the defined threshold of pixels within the defined color values.

In an embodiment, at least a portion of the second set of sub-areas correspond to both the first and second spray heads.

In an embodiment, the color values are in the CIELAB color space and the defined color values correspond to a volume within the CIELAB color space.

In an embodiment, the defined number of sub-areas is one sub-area.

In a third aspect, the invention provides a crop sprayer comprising a spray boom having a plurality of spray heads and apparatus as described above.

Further aspects of the invention, which should be considered in all its novel aspects, will become apparent to those skilled in the art upon reading of the following description which provides at least one example of a practical application of the invention.

### BRIEF DESCRIPTION OF THE DRAWINGS

Example embodiments of the invention will be described below by way of example only, and without intending to be limiting, with reference to the following drawings, in which:

FIG. 1 is a perspective view of apparatus of an embodiment mounted to part of a boom of crop sprayer;

FIG. 2 is a front view of FIG. 1;

FIG. 3 is an example of how components of the apparatus are communicatively connected;

FIG. 4A is a block diagram of an embodiment of a camera node;

FIG. 4B is a block diagram of an embodiment of a central node;

FIG. 5 is a flow chart of an embodiment;

FIG. 6 is an illustrative example of an image being divided into a first set of sub-areas;

FIG. 7 is an example of a range of color values in the CIELAB color space;

FIG. 8 is an illustrative example of an image being divided into a first set of sub-areas;

FIGS. 9 to 11 are examples of images before and after processing;

FIG. 12 is another example of a range of color values in the CIELAB color space; and

FIG. 13 is another example of a range of color values in the CIELAB color space.

### DETAILED DESCRIPTION

Embodiments are disclosed of a method and apparatus for controlling at least one spray head of a crop sprayer as well as a crop sprayer incorporating the apparatus. In the preferred embodiment, the method and apparatus control all of the spray heads of the crop sprayer. In an example, the apparatus comprises one or more cameras that capture images as the crop sprayer traverses a field and one or more controllers that processes the captured images to determine whether or not to turn on associated spray heads based whether sub-areas of the images contain a defined number of pixels within a defined color range, for example a color range corresponding to foliage such as weeds.

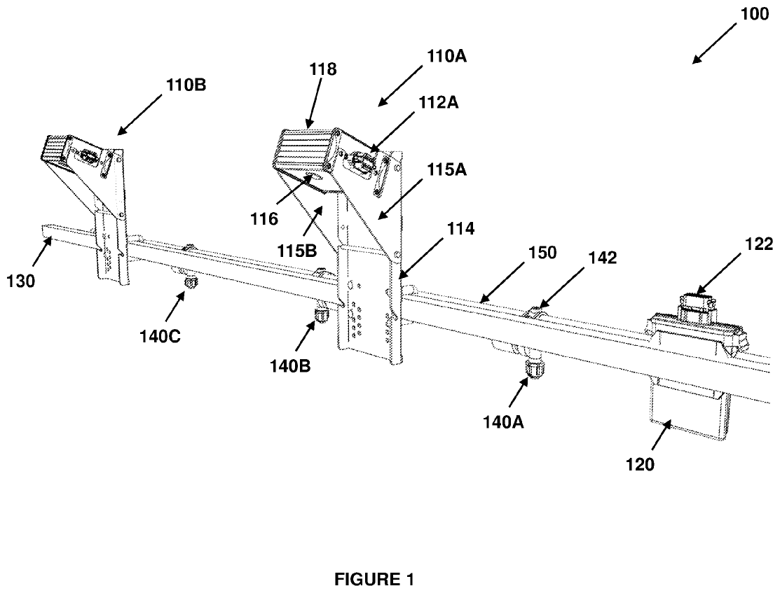

FIG. 1 illustrates example apparatus 100 installed on a section of a boom 130 of a crop sprayer. As illustrated in FIG. 1 in an example embodiment, the apparatus comprises a plurality of camera nodes 110A, 110B and a central node 120. In this example, each camera node 110 is used to control two spray heads (or “nozzles”) 140. Accordingly, it will be appreciated that the number of camera nodes of the apparatus will depend on the number of spray heads to be controlled. A typical crop sprayer will have 6-84 spray heads.

While in the example, of FIG. 1, each camera node 110 controls two spray heads, in other examples, each camera node may control 1, 3 or 4 spray heads. In some examples, individual camera nodes may control different numbers of spray heads to other camera nodes. For example, in the case that the total number of spray heads is not evenly divisible by the chosen number of spray heads per camera node. A trade-off where camera nodes are used to monitor more spray heads is that the camera nodes will typically need to be mounted higher relative to the ground to provide an adequate field of view and as a result may need to use higher definition cameras.

With reference to first camera node 110A, it will be apparent that it has a housing 118 mounted to two angled support arms 115A, 115B of a mounting bracket 114 that is used to attach camera node 110A to the spray boom 130 so that it is forward facing. The housing 118 has a camera window 116 and the camera itself is mounted to a printed circuit board (not shown) disposed within the housing with the camera so that the camera is aligned with camera window 116. The arms 115A hold the housing so that it is angled off the horizontal (in this example at an angle of 22 degrees) in order to enable the camera to capture a color image of an area of the field to be potentially sprayed as the crop sprayer traverses a field. When mounted to a boom arm of a typical crop sprayer, the bracket will position the camera window 116 around 800 mm to 1000 mm off the ground.

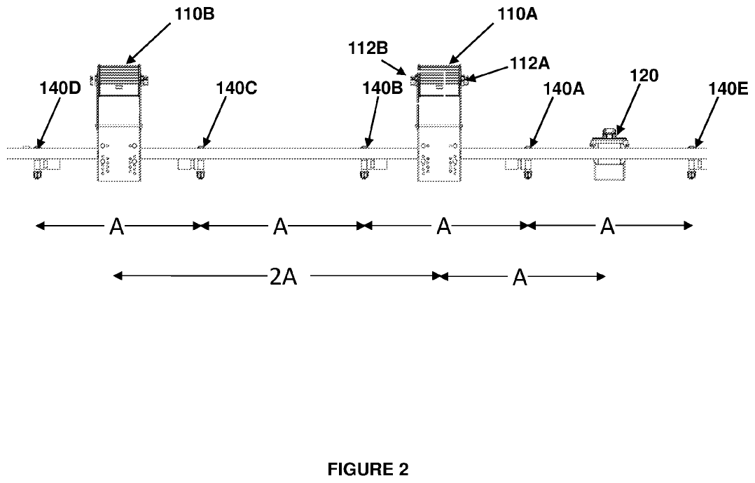

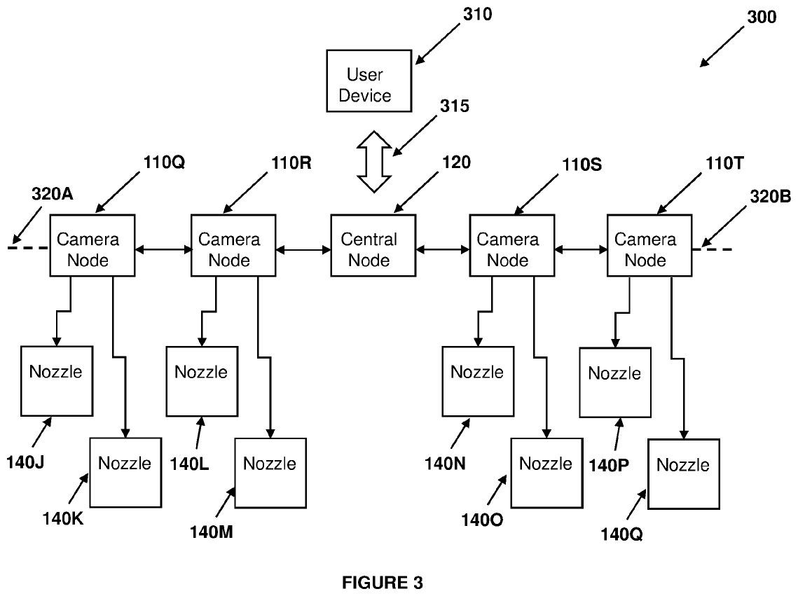

There is a first connector 112A on the right-hand side of housing 118 and, as better seen in FIG. 2, a second connector 112B on the left-hand side. Wiring is not shown in FIGS. 1 and 2 to avoid obscuring other features, however, connectors 112 have ports for connecting the camera nodes 110 in a daisy-chain using a CAN (“Controller Area Network”) bus as well as for connecting the camera nodes 110 to spray head connectors 142. The wiring configuration will be explained in further detail in connection with FIG. 3 below. Central node 120 also has a connector 122 so that it can be connected into the daisy chain. In this respect, it will be appreciated that the central node 120 can be positioned at any convenient position along the spray boom 130 and the wiring adjusted accordingly.

Spray heads 140A, 140B, 140C, 140D are mounted in order to draw fluid from pipe 150 mounted to spray boom 130. Pipe 150 is in fluid communication with a fluid reservoir (not shown) that supplies the spray heads 140.

Referring to FIG. 2, it will be observed that spray heads 140 are evenly spaced by distance A (typically 250-500 mm) and as each camera node 110 services two spray heads 140 the camera nodes 110 are spaced by distance 2A (typically 500-1000 mm). It can also be seen in FIG. 2 that first camera node 110A services first and second spray heads 140A, 140B and second camera node 110B services third and fourth spray heads 140C,140D. Fifth spray head 140E is serviced by a further camera node (not shown). It will be appreciated that while central node 120 is evenly spaced by distance A from camera node 110A, positioning of the central node 120 is not as important. While even spacing of the camera nodes is shown in FIG. 2, in some examples, it may not be possible to obtain precise spacing because of characteristics or other components of the spray boom 130. Discrepancies in spacing/positioning can be addressed by calibration.

As indicated above, FIG. 3 is an illustrative wiring diagram 300. FIG. 3 illustrates an example of four camera nodes 110Q, 110R, 110S, 110T connected in a daisy-chain with central node 120 which in an example, is configured to ensure that the camera nodes operate synchronously. As indicated by dotted lines 320A and 320B, typically further camera nodes will be connected in the daisy-chain. As shown in FIG. 3, each camera node 110Q-110T is connected to two of nozzles 140J-140Q.

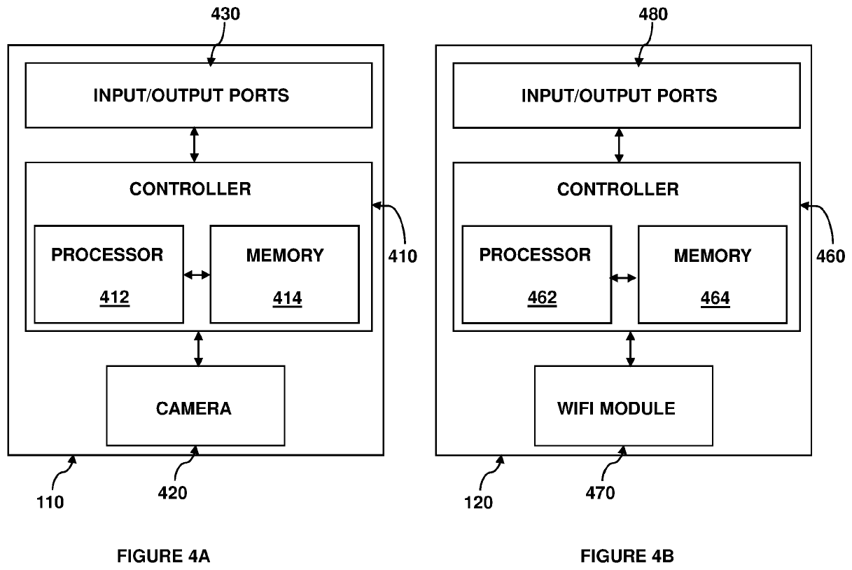

Central node 315 is configured for two-way communication 315 with a user device, such as a smart phone, tablet, or computer. For example, to enable user device to update firmware in the central node 120 or camera node 110 or to change setting of the apparatus. The central node 120 can also communicate data to user device for use in diagnostics. As shown in FIG. 4B, one option for allowing two-way communication is for the central node to have a Wi-Fi module 470. However, in other examples, the central node may have a Bluetooth module in order to connect to a portable user device such as a smart phone. In other example, a cable may be used to connect a user device to the central node (e.g. a USB cable). It will be appreciated that in other examples, alternative communication architectures can be used. For example, camera nodes 110 could communicated over Bluetooth with central node 120 or directly to a portable user device 310.

Referring to FIG. 4A there is shown a block diagram of an example camera node 110. As shown in FIG. 4A, controller 410 comprises a processor 412 and a memory 414. The memory 414 stores program code that is executed by the processor 412 in order to acquire and process images as described herein. Memory 414 also stores settings for acquiring and processing images. The settings can be updated/changed under control of the central node 120.

Camera 420 can be any suitable digital camera. In most use cases a camera having a resolution of 640×480 pixels is suitable for mounting to a crop sprayer because at approximately 1 meter above the ground, each pixel corresponds to approximately 1.5 mm on the ground. It will be appreciated that the selected resolution impacts on cost of the camera and also on processing requirements and thus, potentially, on the cost of the processor. In an example, the target operating speed of the crop sprayer is 12-18 km/h and the apparatus captures images at a rate of ˜30 times per second which is also related to the selected resolution and the processing capacity.

Controller 410 communicates with the central node and the nozzles via input/output ports 430. In an example, for the nozzles the output port 430 is a relay circuit for turning solenoids on the respective nozzles on and off.

FIG. 4B is a block diagram of an example central node 120. As shown in FIG. 4B, a controller 460 has a processor 462 and a memory 464. The memory 464 stores program code that is executed by the processor 462 in order to synchronize the camera nodes 110 by way of commands issued via input/output ports 480, modify settings of the camera nodes 110 in response to instructions from the user device and to communicate with user device via WiFi module 470.

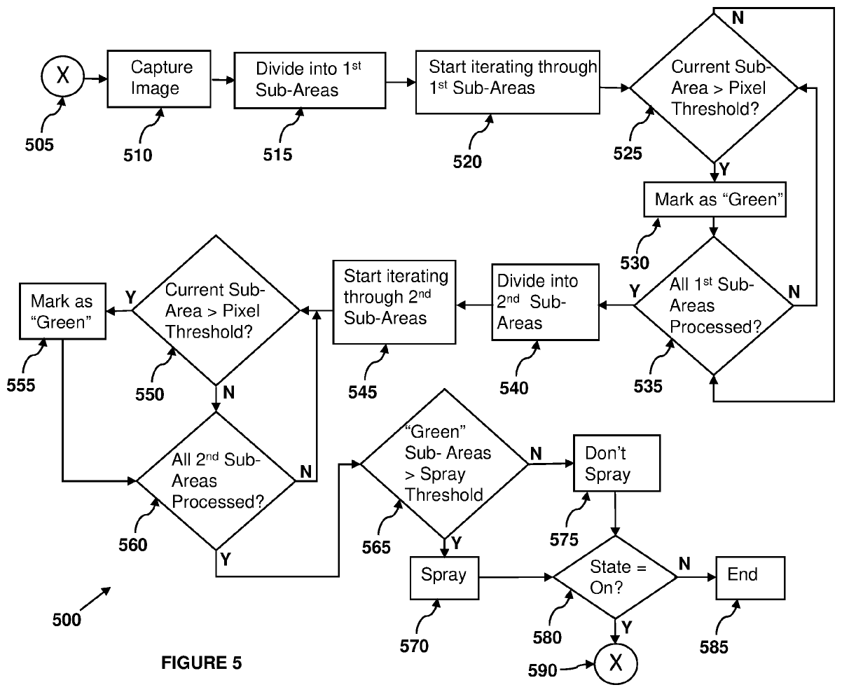

Referring to FIG. 5, there is illustrated an example embodiment of a method 500 of controlling a crop spray head that, in this example, is implemented by each camera node 110 of the apparatus 100.

At step 505, the processor 412 of a respective camera node 110 controls the camera 420 to capture a color image in the CIELAB color space of an area of the field to be potentially sprayed by a spray head 140 that is under the control of the respective camera node 110.

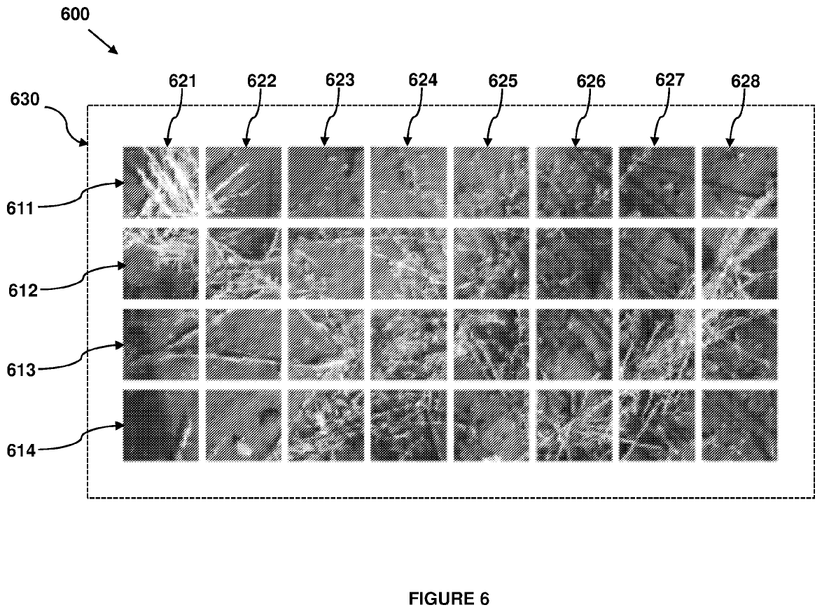

At step 515, the processor 412 divides the captured image into a set of first sub-areas. An illustrative example is provided in FIG. 6. In this example, a captured image 600 is divided into a rectangular array of four rows 611-614 and eight columns 621-628 so that there are thirty-two first sub-areas or “tiles”. In some examples, each sub-area or tile is a 40 by 40 pixel area.

As illustrated in FIG. 6, in some implementations the process of dividing the image into sub-areas may include cropping the image relative to an initial image boundary 630. It will also be noted that in FIG. 6, white lines have been placed between each of the tiles to more clearly show the demarcation between neighboring tiles whereas, in an example implementation, neighboring tiles are contiguous. In this example, the four left hand side columns 621-624 correspond to an area to be potentially sprayed by a first nozzle 140 controlled by the camera node 110 and the four right hand side columns 625-628 correspond to an area to be potentially sprayed by a second nozzle 140 controlled by the same camera node 110.

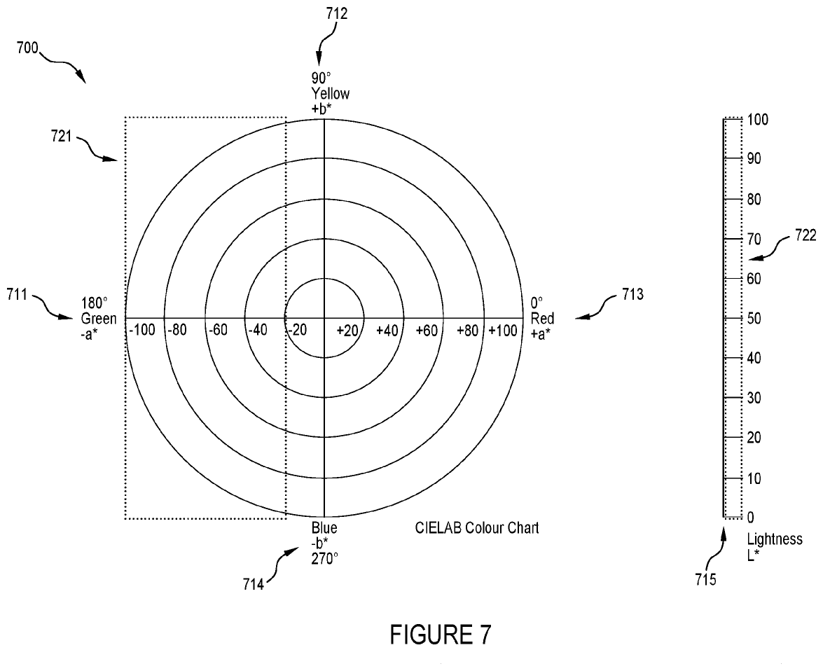

At step 520, the processor 412 begins iterating through the first sub-areas. At step 525, the processor 412 determines whether the current sub-area has more than a defined number of pixels that meet a test for being “Green” (that is, having defined color values corresponding to the color green). This involves, an inner iterative loop (not shown) of determining on a pixel-by-pixel basis whether the respective pixel corresponds to a range of color values that are treated as green by the apparatus. As indicated above, the image is captured in the CIELAB color space. One of the reasons for doing so is that subsequently determining whether a pixel is within a defined range of color values in the CIELAB color space is computationally straightforward. However, the apparatus and method can be adapted to work with other color spaces. An example of defined color values is shown in FIG. 7. FIG. 7 shows the CIELAB color space 700 (also referred to as the L*a*b* color space). The CIELAB color space has a first axis (the a axis) between yellow 712 and blue 714 and a second axis between green 711 and red 713 (the b axis). In addition, there is a lightness axis 715 (the L axis) between 0 and 100. Boxes 721 and 722 illustrate the volume with the CIELAB color space that will be treated as green. In this example, the volume is defined by having a value on the a axis between −20 and −100 as shown by box 721 (i.e. independent of the value on the b axis and the lightness value. This makes processing individual pixels computationally efficient. In other embodiments, more complex definitions for defined color values may be employed.

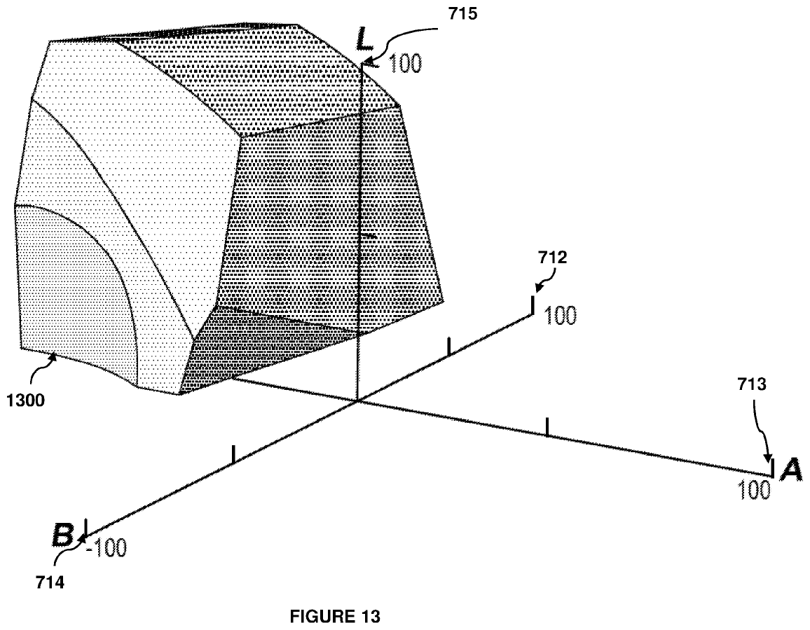

FIG. 13 is an example of a more complex definition of a set of color values 1300, where the CIELAB color space is represented three-dimensionally in order to illustrate the set of color values. In practice, the color values can be stored as a look-up table in memory. For example, by a table defining an area in the plane of the a and b axes for each possible lightness value.

After all the pixels have been processed it is determined whether there are enough “green” pixels to mark a sub-area as green at step 530. The pixel threshold is set based on a number of factors such as the number of pixels within a sub-area and the range of colors that are treated as being “green” (or whatever range of color values that corresponds to foliage to be sprayed). In some examples 2-4 pixels may be appropriate. In another example, a single pixel may be sufficient.

After a sub-area has been marked as green at step 535 or it is determined at step 525 that there are not more “green” pixels that the pixel threshold, it is determined at step 535 whether all of the first sub-areas have been processed. If not, the processor 412 iterates to the next sub-area (e.g. working from the left most column 621 in the top row 611 to the right most column 628 in the bottom row 614).

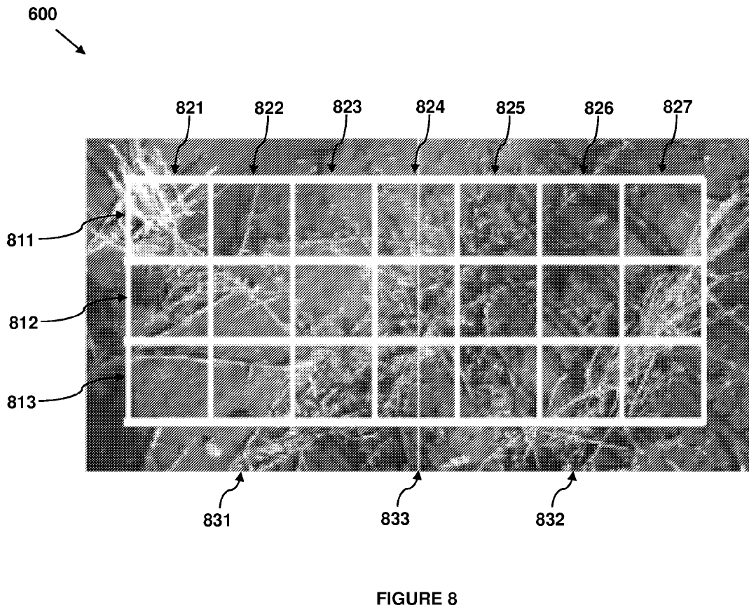

After all the first sub-areas have been processed, processor 412 proceeds to step 540 and divides the image into a second set of sub-areas arranged in overlapping relationship with at least a portion of the first set of sub-areas. An example of a second set of sub-areas is shown in FIG. 8. In this example, the second set of sub-areas is a rectangular array of three rows 911-617 and eight columns so that there are twenty-one second sub-areas and each second sub-is positioned so that it evenly overlaps four of the first sub-areas. Advantageously, the middle column straddles the dividing line 833 between the left 831 and right 832 side of the images such that the middle column corresponds to both the first and second nozzles.

Processor 412 then carries out steps 545 to 560 for the second set of sub-areas; these being equivalent to steps 520 to 535 described above. That is, at step 545, processor 412 begins iterating through the sub-areas. At step 550, processor 412 determines whether a current sub-area has more that a threshold of pixels that are within the define color range and, if so, the sub-area is marked as green at step 555. Step 560 ensures all sub-areas are processed.

After all second sub-areas are processed, at step 565, the processor 412 determines for each spray head whether the number of “green” sub-areas correspond to the respective spray head is greater than or equal to a defined number of sub-areas for triggering spraying. In some examples, a single “green” sub-area triggers spraying. Depending on the outcome of step 565, the processor proceeds to step 570 of “Spray” or step 575 “Don't Spray”. In this example, on reaching a decision to spray, at step 570, and assuming the spray head is currently off, processor 412 activates the spray head for a defined period of time based on the speed of travel of the crop sprayer (for example 200 ms). Then at step 580, the processor 412 determines whether the apparatus is still in an on state and, if so, reverts back to step 510 to process the next capture image as indicated by process connector “X” 590, 505.

When in a subsequent iteration it is decided to spray at step 570, the processor 412 resets the off timer for the respective spray head. Accordingly, if at step 575, the decision is to not spray, processor 412 leaves the off timer running. As a result, the relevant spray head will remain on while the off timer is running and be turned off a defined period after the last green sub-area.

When it is determined at step 580 that the crop sprayer is no longer on, the process ends 585.

It will be appreciated that at step 565, because the sub-areas of middle column 824 of the second set of sub-areas, overlap the center line 833, they can contribute to both the first and second nozzle being turned on if they are found to have sufficient green pixels.

It will be appreciated that the above method 500 results in all of the sub-areas being processed. An advantage of proceeding in this way is that data can be captured to implement quality control and refine the settings. In other implementations, processing shortcuts may be implemented, for example by ending iteration loops for finding pixels having a defined color or sub-areas with a defined number of pixels having the defined colors as soon as the relevant threshold has been reached.

It will be appreciated that other arrangements of a second set of overlapping sub-areas can be employed, for example, an embodiment employing only the central column 824 will provide some improvement relative to just employing the first set of sub-areas. Other shapes of sub-areas than the rectangular array are also possible but the configuration described above is computationally efficient to implement.

Testing was conducted to determine the improvement offered by using a second set of sub-areas (referred to as the offset grid in Table 1 below). It can be seen that while using a single grid results in many detections, additionally using an offset grid improves detection of sub-areas that should be sprayed by approximately 3-5% depending on the threshold value for treating individual pixels as green.

TABLE 1

| | Successful Detections | | |
|---|---|---|---|
| Green Threshold | No Offset Grid | Offset Grid | Improvement |
| −16 | 400 | 412 | 2.91% |
| −18 | 304 | 315 | 3.49% |
| −20 | 215 | 226 | 4.87% |

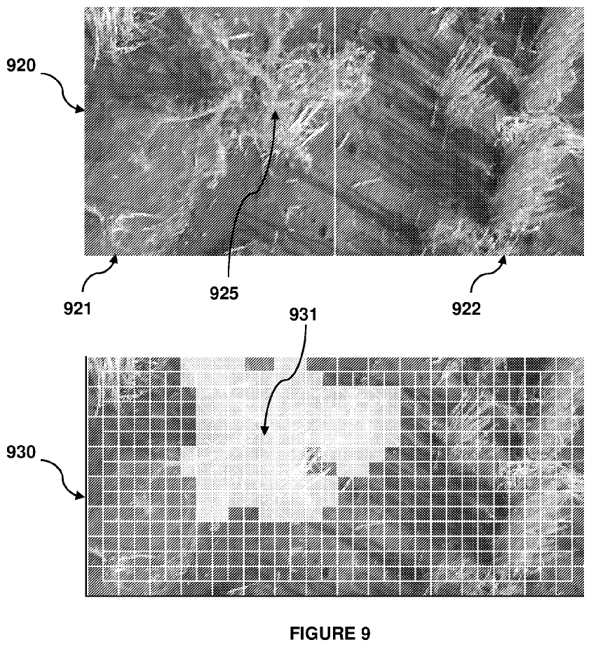

FIGS. 9 to 11 show examples of original and processed images. In FIG. 9, the original image 920 has a left side 921 corresponding to a first spray head and a right side 922 corresponding to a second spray head.

The processed image 930 shows that in this example, the first array of sub-areas has 8 rows and 16 columns (8 for each half of the image), and the second, overlapping array has 7 rows and 14 columns. It will be seen that a region 931 of the processed image comprises sub-areas marked as to be sprayed which will cause both spray heads (nozzles) to be activated. This region 931 corresponds to the weed 925 that can be found in the original image.

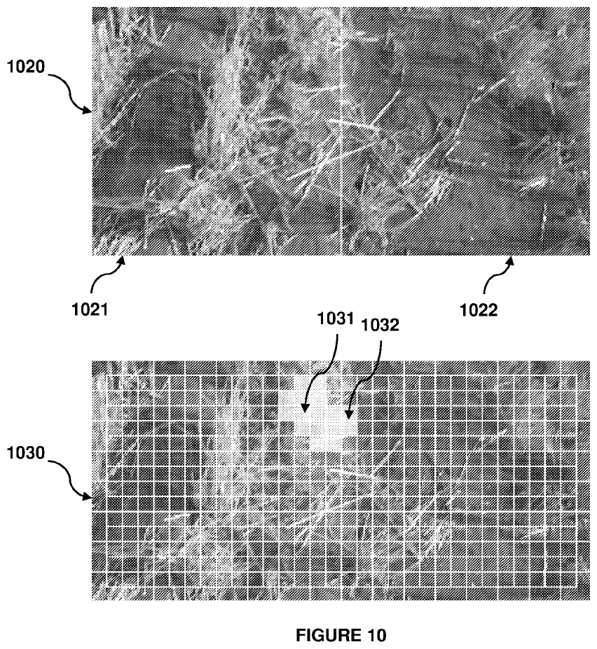

In FIG. 10, the original image 1020 has a left side 1021 corresponding to a first spray head and a right side 1022 corresponding to a second spray head.

The processed image 1030 shows that region 1031 of the processed image comprises sub-areas marked as to be sprayed. It will be observed that in this example, the only sub-area 1032 that corresponds to the right-hand side of the image is from the second array of overlapping sub-areas. That is, in this example, the second spray head would not have been activated if only the first array of sub-areas had been processed.

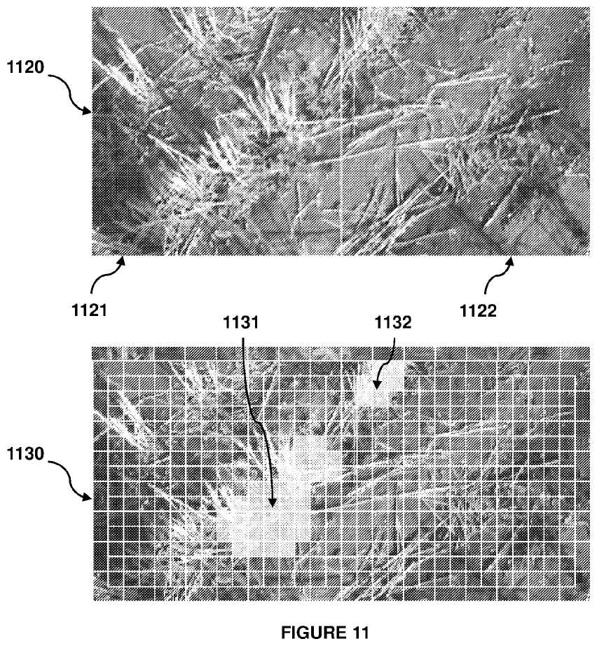

In FIG. 11, the original image 1120 has a left side 1121 corresponding to a first spray head and a right side 1122 corresponding to a second spray head. The processed image 1130 shows that region 1131 and 1132 have been separately identified in each of the left and right sides 1120,1121 and hence both spray heads will be activated.

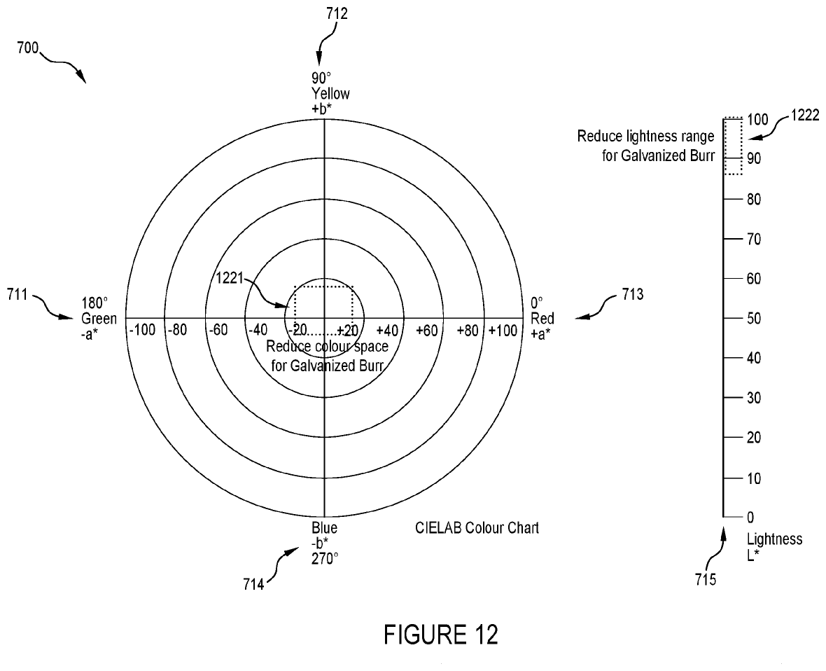

FIG. 12 illustrates that careful selection of other ranges of color values can be used to target foliage. In this example, a range of values within the CIELAB color space as defined by boxes 1221 and 1222 corresponds to the weed Galvanised Burr which is bluish in appearance compared to the surrounding crop.

Unless the context clearly requires otherwise, throughout the description and the claims, the words “comprise”, “comprising”, and the like, are to be construed in an inclusive sense as opposed to an exclusive or exhaustive sense, that is to say, in the sense of “including, but not limited to”.

Reference to any prior art in this specification is not, and should not be taken as, an acknowledgement or any form of suggestion that that prior art forms part of the common general knowledge in the field of endeavor in any country in the world.

The invention may also be said broadly to consist in the parts, elements, characteristics and features referred to or indicated in the specification of the application, individually or collectively, in any or all combinations of two or more of said parts, elements, characteristics or features.

Aspects of the present invention have been described by way of example only and it should be appreciated that modifications and additions may be made thereto without departing from the scope thereof as defined herein.

Where in the foregoing description reference has been made to integers or components having known equivalents thereof, those integers are herein incorporated as if individually set forth.

It should be noted that various changes and modifications to the presently preferred embodiments described herein will be apparent to those skilled in the art. Such changes and modifications may be made without departing from the spirit and scope of the invention and without diminishing its attendant advantages. It is therefore intended that such changes and modifications be included within the present invention.

1. A method of controlling at least one spray head of a crop sprayer, the method comprising the steps of:
(a) capturing, as the crop sprayer traverses a field, a color image of an area of the field to be potentially sprayed by a first spray head;
(b) dividing at least part of the captured image into a first set of sub-areas;
(c) determining whether at least a defined number of the sub-areas corresponding to the first spray head include at least a defined number of pixels having defined color values corresponding to foliage to be sprayed; and
(d) activating the first spray head upon at least the defined number of the sub-areas areas corresponding to the first spray head having more than the defined threshold of pixels within the defined color values.

2. The method as claimed in claim 1, comprising determining whether to activate the first spray head in step (d) after determining in step (c) whether each of the sub-areas includes more than a defined threshold of pixels having defined color values corresponding to foliage to be sprayed.

3. The method as claimed in claim 1, comprising determining whether to activate the spray head in step (d) after each determination in step (c) that an individual one of the first set of sub-areas includes more than a defined threshold of pixels having defined color values corresponding to foliage to be sprayed.

4. The method as claimed in claim 2, further comprising:
determining whether to activate the first spray head in step (d) after:
dividing at least part of the captured image into a second set of sub-areas arranged in an offset, overlapping relationship with at least a portion of the first set of sub-areas; and
determining whether at least a defined number of the first and second sets of sub-areas include at least a defined number of pixels having defined color values corresponding to foliage to be sprayed.

5. The method as claimed in claim 3, further comprising, upon the spray head not having been activated:
dividing at least part of the captured image into a second set of sub-areas arranged in offset, overlapping relationship with at least a portion of the first set of sub-areas; and
determining whether to activate the first spray head in step (d) after each determination that an individual one of the second set of sub-areas includes more than a defined threshold of pixels having defined color values corresponding to foliage to be sprayed.

6. The method as claimed in claim 4, wherein the captured color image also corresponds to an area of the field to be potentially sprayed by a second spray head, and the method comprises:
determining whether at least a defined number of sub-areas corresponding to the second spray head include at least a defined number of pixels having defined color values corresponding to foliage to be sprayed; and
activating the second spray upon at least the defined number of the sub-areas corresponding to the second spray head having more than the defined threshold of pixels within the defined color values.

7. The method as claimed in claim 6, wherein at least a portion of the second set of sub-areas corresponds to both the first and second spray heads.

8. The method as claimed in claim 1, wherein the color values are in the CIELAB color space.

9. The method as claimed in claim 6, wherein the defined color values correspond to a volume within the CIELAB color space.

10. The method as claimed in claim 1, wherein the defined number of sub-areas is one sub-area.

11. Apparatus for controlling at least one spray head of a crop sprayer:
a camera for capturing, as the crop sprayer traverses a field, a color image of an area of the field to be potentially sprayed by a first spray head; and
a controller coupled to the camera and the spray head, the controller configured to:
(a) divide at least part of the captured image into a first set of sub-areas;
(b) determine whether at least a defined number of the sub-areas corresponding to the first spray head include at least a defined number of pixels having defined color values corresponding to foliage to be sprayed; and
(d) activate the first spray head upon at least the defined number of the sub-areas areas corresponding to the first spray head having more than the defined threshold of pixels within the defined color values.

12. The apparatus as claimed in claim 11, wherein the controller is further configured to determine whether to activate the first spray head in step after determining whether each of the sub-areas includes more than a defined threshold of pixels having defined color values corresponding to foliage to be sprayed.

13. The apparatus as claimed in claim 11, wherein the controller is further configured to determine whether to activate the spray head in after each determination that an individual one of the first set of sub-areas includes more than a defined threshold of pixels having defined color values corresponding to foliage to be sprayed.

14. The apparatus as claimed in claim 12, wherein the controller is further configured to determine whether to activate the first spray head after:
dividing at least part of the captured image into a second set of sub-areas arranged in offset, overlapping relationship with at least a portion of the first set of sub-areas; and
determining whether at least a defined number of the first and second sets of sub-areas include at least a defined number of pixels having defined color values corresponding to foliage to be sprayed.

15. The apparatus as claimed in claim 13, wherein the controller is further configured to, upon the spray head not having been activated:
divide at least part of the captured image into a second set of sub-areas arranged in offset, overlapping relationship with at least a portion of the first set of sub-areas; and
determine whether to activate the first spray head in step (d) after each determination that an individual one of the second set of sub-areas includes more than a defined threshold of pixels having defined color values corresponding to foliage to be sprayed.

16. The apparatus as claimed in claim 4, wherein the captured color image also corresponds to an area of the field to be potentially sprayed by a second spray head, and the controller is configured to:
determine whether at least a defined number of sub-areas corresponding to the second spray head include at least a defined number of pixels having defined color values corresponding to foliage to be sprayed; and
activate the second spray upon at least the defined number of the sub-areas corresponding to the second spray head having more than the defined threshold of pixels within the defined color values.

17. The apparatus as claimed in claim 16, wherein at least a portion of the second set of sub-areas correspond to both the first and second spray heads.

18. The apparatus as claimed in claim 1, wherein the color values are in the CIELAB color space and the defined color values correspond to a volume within the CIELAB color space.

19. The apparatus as claimed in claim 11, wherein the defined number of sub-areas is one sub-area.

20. A crop sprayer comprising: a spray boom having a plurality of spray heads; and the apparatus as claimed in claim 11 for controlling the spray heads.
